(19) United States
(12) Patent Application Publication
(10) Pub. No.: US 2003/0106325 A1
(43) Pub. Date: Jun. 12, 2003

(54) Cryogenic fluid transfer tube

(76) Inventor: Mark J. Robbie, Livingston West Lothian (GB)

Correspondence Address: Carol A Lewis White, W L Gore & Associates Inc, 551 Paper Mill Road, Newark, DE, 19714-9206, US

(21) Appl. No.: 10/220,031

(22) PCT Filed: Feb. 20, 2001
(86) PCT No.: PCT/GB01/00685

(30) Foreign Application Priority Data
Feb. 22, 2000 (GB) 0004174.9

(51) Int. Cl. F17C 13/00; F16L 9/18; F16L 11/00

(52) U.S. Cl. 62/50.7; 138/114

(57) ABSTRACT

The present invention is an improved tube for the effective transfer of cryogenic fluids and the like. The transfer tube (22) comprises at least two tubes, an inner tube (30) coaxially housed within an outer tube (44) with a defined gap therebetween. The inner tube is sufficiently permeable to gaseous cryogenic fluid that it allows release of limited amounts of gaseous fluid into the defined gap. The outer tube is essentially impermeable so as to contain the gaseous fluid within the gap. Preferably both tubes are constructed from flexible and cold temperature resistant polymer materials, such as fluoropolymer materials and especially expanded polytetrafluoroethylene (PTFE) and/or fluorinated ethylene propylene (FEP). The transfer tube of the present invention is highly effective at cryogenic fluid transfer while being lighter, more flexible, and more efficient than currently available transfer tubes.

### FIELD OF THE INVENTION

The present invention relates to tubes for transfer of cryogenic fluids, and to containers for storage of cryogenic fluids.

### DESCRIPTION OF RELATED ART

Vacuum and dry gas insulated tubes are typically used to transport or store cold liquids or liquids with a low heat of vaporisation. The coaxial design of these transfer tubes reduces the warming rate of the cold liquid and results in a reduced exterior temperature. These transfer tubes usually consist of two straight, corrugated or convoluted stainless steel tubes mounted one over top of the other. The use of multiple tubes provides some degree of insulation to help maintain low temperature liquids in a liquid state. The use of corrugations or convolutions lends somewhat increased flexibility (i.e., a reduced bending radius) to the construction. A protective stainless steel mesh is often applied to the outer surface of the transfer tube. Overall, these transfer tubes suffer from numerous problems, including poor bend radius, excessive weight and size, and prolonged time to deliver cold liquids due to the initial cooling of the tubing which is necessary before the liquid may pass through the tubing without significant vaporisation.

Alternative tubes in the prior art are much like the tubes described above except that they do not provide a coaxial insulating space. Consequently, they do not provide the same insulating benefits. These tubes are typically used to deliver cold liquids over relatively short distances, such as delivering liquids from a storage tank. These transfer tubes also suffer from a poor bend radius, large mass, prolonged time to deliver cold liquids and excessive frost accumulation on the outer surface of the tube and subsequent pooling of water in the vicinity.

U.S. Pat. No. 4,745,760 to Porter (NCR Corporation) discloses a cryogenic fluid transfer conduit. The conduit transfers the fluid through an impermeable tube from a cryogenic reservoir to an enclosure for cooling an integrated circuit, and its coaxial channel is used to return the fluid to the reservoir. This apparatus relies on the fluid delivered out of the end of the tube to be re-directed into the coaxial space for improved insulative properties.

A closed ended surgical cryoprobe instrument is described in U.S. Pat. No. 5,520, 682 to Baust et al. This patent teaches the use of a closed system to chill the end portion of a surgical instrument. An impermeable inner tube is provided to deliver cooling fluid, with no fluid delivered outside of the chambers of the device.

U.S. Pat. No. 4,924,679 to Brigham et al. describes an insulated cryogenic hose. A fluid that liquefies or solidifies at cryogenic temperatures fills the coaxial space of the article of this invention to improve insulation, but at the cost of loss of overall flexibility of the tube.

Various polymers are known to be useful under low temperature conditions such as 77° Kelvin (the temperature at which Nitrogen will remain liquid at atmospheric pressure). For example, porous polytetrafluoroethylene (PTFE) is known to retain strength and flexibility at low temperatures, particularly in the form of porous expanded PTFE (ePTFE) constituted by nodes interconnected by fibrils as described in U.S. Pat. No. 3,953,566 to Gore. Such ePTFE, however, is not normally suitable for the transport or storage of cryogenic liquids because of its porosity, which allows cryogenic liquids to have ready passage into and through the ePTFE material.

Temperature gradients affecting materials used in systems such as those involving cryogens are such that thermal expansion and contraction effects may cause early mechanical failure in components. Preferred embodiments of this invention, in addition to possessing certain permeation characteristics, relate to materials that retain flexibility and strength at low temperatures, such as 77° Kelvin.

### SUMMARY OF THE INVENTION

One embodiment of the present invention entails a porous inner tube arranged coaxially with a porous or non-porous outer tube for the purpose of transporting or containing cryogenic fluids. The annulus between the two tubes becomes filled with the gaseous form of the cryogenic fluid delivered or contained within the inner tube. The inner tube wall permits the passage of the dry gaseous cryogenic fluid while restricting the passage of the fluid in the liquid state. As a consequence, a thermal insulating layer is simply and easily created. The inner and outer tubes are preferably made from polymeric materials, particularly fluoropolymers.

Embodiments of the invention may also comprise three or more tubes and define two or more annular volumes therebetween.

The construction also results in transfer tubes possessing considerably less mass per unit length than conventional transfer tubes, many of which are constructed of stainless steel. The use of fluoropolymers also enables the design of more flexible tubes that can also withstand more flexural stresses prior to failure. Also, such embodiments of the present invention provides for quicker delivery of cryogenic liquids than available with prior art transfer tubes, due to the relatively low heat capacity and thermal conductivity of such materials.

In one embodiment, the invention comprises a fluid transfer conduit system comprising a permeable inner tube adapted to contain a liquid cryogenic fluid; an outer tube, the outer tube being mounted around the inner tube; and a gap between the inner tube and the outer tube, the gap adapted to contain a gaseous phase of the cryogenic fluid.

Shaped articles of the embodiments of the present invention are capable of containing and delivering a cryogenic fluid. These articles comprise a porous or non-porous outer tube arranged coaxially with a porous inner tube. The inner tube wall has a porous structure that restricts the passage of cryogenic fluid in the liquid phase while permitting the passage of cryogenic fluid in the gaseous phase. Such fluids may include nitrogen, helium, hydrogen, argon, neon, and air as well as liquefied petroleum gas or low temperature liquids.

By “restrict” or “restriction” in this context is meant that while gas can exit a material of the present invention through its exterior surface, liquid will enter into the thickness of the material but will not pass as a liquid through its exterior surface under specific operating conditions (e.g., temperature, humidity, pressure, etc.).

By “low temperature” in this context is meant a temperature substantially below 0° C. Typically liquid nitrogen, for example, is liquid at temperature of approximately 77° Kelvin (−196° C.) at an atmospheric pressure of one atmosphere.

Articles of embodiments of the present invention are distinguishable from those in the prior art in a number of ways. A primary difference is that the present transfer tube entails the use of a porous tube. Since the purpose of a transfer tube is to maximise fluid delivery from one end to the other of the tube, it is counterintuitive to utilise porous tubes to transport fluids. The effectiveness of the transfer tube of embodiments of the present invention is also surprising. That is, cryogenic liquids are delivered quicker than by currently available transfer tubes.

In order to achieve this result, special design considerations had to be satisfied for the preferred inner tube. Specifically, the material of the inner tube for the transport of a cryogenic fluid has a porous structure that allows a liquid cryogenic fluid to enter through a first surface of the material into the thickness of the material but restricts leakage of liquid cryogenic fluid through the exterior, or second, surface. The first and second surfaces are separated by the thickness. The restriction may occur within the thickness of the material and/or at the first and/or second surface. Furthermore, the material preferably also controls passage of the cryogenic fluid in gaseous phase through the exterior surface of the material.

Porous tubes conventionally found in the prior art do not accomplish this function. Due to the excessively low surface tension of cryogenic liquids, even in conventional tubes consisting of ePTFE, the liquid readily wets the tube material and leaks through the wall. Particular design features of the preferred embodiments of the present invention create a porous tube that does not leak cryogenic liquids at the desired operating pressures.

In a preferred form, the invention provides an inner tube that serves as a liquid permeation restriction material that preferably is lightweight and flexible at low temperatures. The construction allows gaseous insulation of the annular space within the transfer tube that results in enhanced effectiveness of cryogenic liquid transfer. Preferably also, a plurality of layers of material are superimposed on each other to provide a multi-layered composite material possessing a spiral-shaped cross-section, formed from one or more sheets of film. Furthermore, the inner tube possessing a spiral-shaped cross-section may be comprised of more than one type of film. A base tube may also be incorporated into the construction. The preferred film and base tube materials are ePTFE.

The film layers may be wrapped about the longitudinal axis of a mandrel. The film may be circumferentially wrapped such that the film width becomes the length of the tube. Alternatively, long length tubes may be constructed by helically wrapping film. Helical wrapping in two directions may impart different properties to the tubes. The layers are bonded together by restraining the ends of the tube on the mandrel and then subjecting the assembly to temperatures above the crystalline melt point of PTFE. The cooled tube is then removed from the mandrel.

The porous material of the invention results in a product that preferably has a high restriction to the through-flow of liquid through the wall of the material while having a low content of solid material. This preferred material provides improved mechanical and permeation characteristics particularly when used in a multi-layered construction. A multi-layered construction may result in an article that exhibits low bending stresses, thereby increasing its fatigue life. The summation of several layers of material may also increase the pressure required to force liquid cryogen through to the exterior surface.

The porous tube-forming material of embodiments of the present invention may be utilised to restrict liquid cryogen permeation through the material to a rate that will facilitate heat loss through liquid to vapour phase change within the material and at the external surface of the material.

The preferred inner tubes enable the passage of the gaseous phase of cryogenic fluids across the thickness direction of the inner tube, while inhibiting the passage of the liquid phase of the fluids across the thickness direction. In these tubes, the mass flow rate of the liquid phase of a cryogenic fluid flowing through the wall in the thickness direction is less than or equal to the mass evaporation rate of the liquid at the outer wall surface. The material may be modified to alter the restriction of liquid phase cryogenic fluid passage and the controlled release of gaseous phase cryogenic fluid through the exterior of the material. A preferred article in the form of an inner tube of a coaxial transfer tube has a liquid nitrogen leak pressure (LNLP) (based on the test described below) of at least 0.3 psi (0.002 MPa) and does not fracture during flexure at cryogenic temperatures. Tubes having higher values for LNLP and that do not fracture at these temperatures are more preferred for use in this application; a more preferable inner tube for use in a transfer tube possesses a liquid nitrogen leak pressure (LNLP) such as at least 7.35 psi (0.051 MPa). For certain cryogenic fluid transfer applications, LNLP values up to 45 psi (0.310 MPa) are desirable. Such a tube may be constructed by combining multiple layers of ePTFE materials though possibly at the cost of reduced tube flexibility. In certain applications, the desirable LNLP may be up to 100 psi (0.690 MPa) or even up to 400 psi (2.76 MPa) or more.

Any suitable porous material may be used as the inner tube, including polymers, metals, ceramics and mixtures or composites thereof. Fluoropolymer is considered suitable, and porous expanded PTFE (ePTFE) is a particularly preferred material because of its flexibility at cryogenic temperatures, and the ability to fabricate a tube and other forms from ePTFE with a desired permeability. Although ePTFE is not brittle at very low temperatures, care must be taken in the construction of tubes, and other forms, to ensure that the structure or density of the final tube does not lead to fracture at these temperatures. Non-porous tubes not only typically possess extremely poor permeation properties, they also tend to be unacceptably stiff and prone to fracture, especially at cryogenic temperatures. Low porosity tubes also appear prone to fracture at cryogenic temperatures.

For the purposes of the present invention, the terms “porous” and “non-porous” are defined as follows. A porous material contains open cell pore spaces that allow detectable passage of gaseous fluid across the material (e.g. as detected by a 280 Combo Analyser supplied by David Bishop Instruments, Heathfield, East Sussex, UK). A non-porous material does not contain continuous void spaces across the material thereby limiting the passage of any substantial amount of fluid across the material.

PTFE-based articles of embodiments of the present invention are also preferred because of the low thermal conductivity of PTFE, which is about 0.232 Watts/m.K. Porous articles of PTFE exhibit even lower thermal conductivity. The use of low thermal conductivity materials may result in safer articles with regard to issues such as potential for cold burns. Cryogenic fluid systems will benefit from lower thermal energy ingress and resulting reduction in gas generation within the fluid transport lines. PTFE additionally has a low heat capacity, namely 1047 kJ/kg K.

The choice of precursor ePTFE film material is a function of the desired number of layers in the final tube, tube wall thickness, air permeability, and pore size of the final tube. Pore size may be assessed by isopropanol bubble points (IBP) measurements. Films possessing high IBP values may produce final tubes with higher values for LNLP. The use of smaller pore size films appears to increase the LNLP of the final tube. Increased number of layers and increased film thickness may also increase the LNLP of the final tube. The number of layers is preferably at least 8, more preferably at least 20. More layers may be required in order to provide a desired LNLP while optimizing flexibility of the tube. The desirable number of layers could potentially be as high as 50 or more. An ePTFE base tube may also be part of the construction, but the inclusion of a base tube appears not to be critically important. A suitable tube may be constructed using a porous ePTFE film possessing a thickness of about 0.003 inch (0.076 mm), a Gurley number of about 37 seconds and an IBP of about 50 psi (0.34 MPa).

The inner tube may incorporate convolutions or corrugations to enhance its bending and flex endurance characteristics. Reinforcement members may be incorporated helically, circumferentially, longitudinally or by combinations thereof to enhance tube characteristics. The reinforcement members may be placed within or on the exterior surface of the tubular article. They may enhance the bending characteristics and flexural durability of the tube. Externally applied reinforcement in the form of rings or helically applied beading or filament or other configurations or materials may be incorporated into the inner tube construction in order to provide kink and/or compression resistance to the article. The reinforcement materials may include, but are not limited to, fluoropolymers (such as PTFE, ePTFE, fluorinated ethylene propylene (FEP), etc.), metals, or other suitable materials.

A non-porous outer tube is preferably constructed from a polymer, particularly a fluoropolymer such as PTFE or FEP. These materials are reasonably durable and flexible at cryogenic temperatures, though not as flexible as porous ePTFE. In articles in accordance with embodiments of the present invention the inventive construction, however, the outer tube does not reach the same temperatures as the inner porous tube inasmuch as it is not in full contact with a cryogenic liquid. The outer tube may also be convoluted or corrugated in order to further improve its flexibility. The outer tube may be constructed from other materials, such as metals.

Alternatively, a porous outer tube may be constructed by any of the methods used in the construction of the porous inner tube and may comprise any of the materials previously herein described for the construction of the inner tube

### DESCRIPTION OF THE DRAWINGS

Embodiments of the present invention will now be described, by way of example, with reference to the accompanying drawings, in which:

FIG. 1 is a three-quarter isometric view, shown partially in cut-away, of a tubular article in accordance with one embodiment of the present invention;

FIG. 2 is a three-quarter isometric view illustrating a first method of producing an article in accordance with an embodiment of the present invention, said article being in the form of a tube;

FIG. 3 is a transverse cross-section view of a tubular article in accordance with one embodiment of the present invention;

FIG. 4 is a schematic view of a tube of the present invention attached to test apparatus for testing the efficiency of tubular articles in accordance with embodiments of the present invention;

FIG. 5 is a three-quarter isometric view, shown partially in cut-away, of a first tubular article of the prior art;

FIG. 6 is a three-quarter isometric view, shown partially in cut-away, of another tubular article of the prior art;

FIG. 7 is a schematic view of one form of test apparatus for testing the efficiency of component tubular articles in accordance with embodiments of the present invention;

FIG. 8 is a graphical presentation of the data obtained from cryogenic liquid delivery testing of tubes of the present invention compared with two prior art tubes as illustrated in FIGS. 5 and 6; and

FIG. 9 is a cross-section view of another embodiment of the present invention in which a permeable container is contained in an impermeable flask.

### DETAILED DESCRIPTION OF THE INVENTION

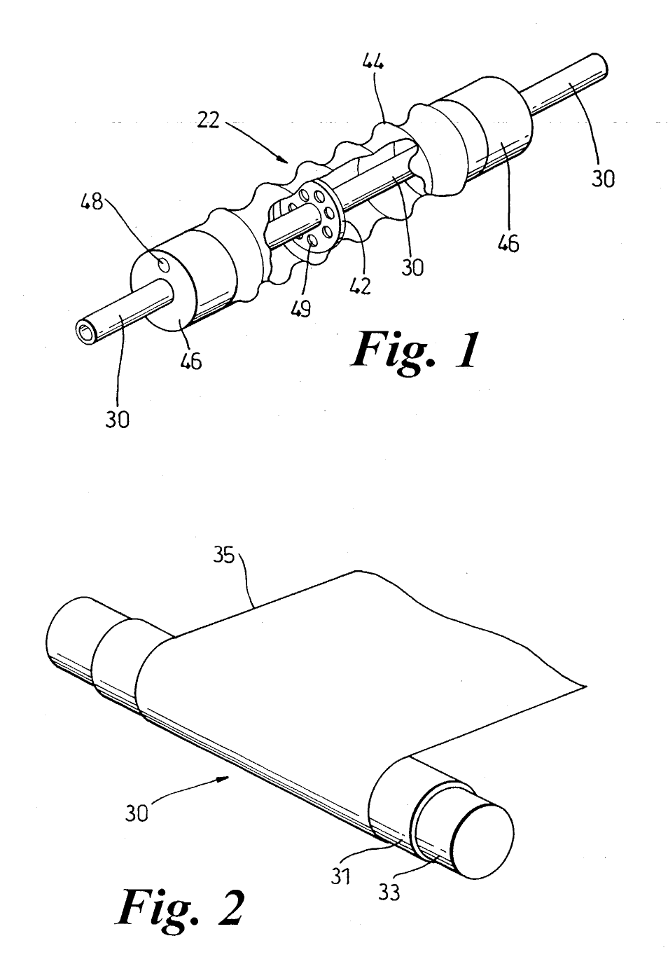

Referring to the drawings, FIG. 1 illustrates a transfer tube 22 an embodiment of the present invention. A coaxial construction is assembled by placing spacers 42 over permeable tubular article 30, then placing the inner tube with spacers inside an outer tube 44. By “permeable” in this context is meant that a detectable amount of fluid passes through the inner tube wall to the exterior of the tube as evidenced, for example, by a plume of condensed water vapour in the vicinity of the tube during fluid transfer. Also in this context, a tubular article said to be “impermeable” does not meet the above criteria for “permeable.” The ends of the coaxial construction are closed with end caps 46 with compression fittings (not shown). An optional vent hole 48 may be drilled into one or both end caps. Multiple spacers 42 or a continuous spacing material (such as a foam material) may be used. Holes 49 are drilled in the spacers to permit the flow of gas along the length of the transfer tube. Preferred spacer materials include, but are not limited to, rigid plastics (such as PTFE, Delrin®, nylon, and the like), metals, and open cell foams. The outer tube 44 is preferably made from a polymer, even more preferably a fluoropolymer, such as PTFE or FEP. Additionally, the outer tube is preferably corrugated or convoluted, as shown, to enhance bending and flex endurance characteristics.

The coaxial transfer tube, as described, is capable of filling the coaxial space with the gaseous phase of the cryogenic liquid contained within the inner tube and is capable of containing the gas in that space without significant leakage to the exterior surface of the outer tube. This feature is measurable, for example, by verifying the pressure increase in the coaxial space subsequent to introducing cryogenic fluid into the inner tube.

FIG. 2 illustrates a method of producing a tubular article 30 of an embodiment of the invention. In this method a base tube 31 is placed over a mandrel 33. The presence of this base tube assists in removing the tube construction from the mandrel. Next, one or more layers of film 35, such as porous expanded polytetrafluoroethylene (ePTFE) film, is or are helically wrapped around the base tube 31 and mandrel 33. The tube 30 should be permeable and also sufficiently strong in the longitudinal direction to enable its removal from the mandrel without suffering damage. Helically wrapping in two directions may impart different properties to the tube.

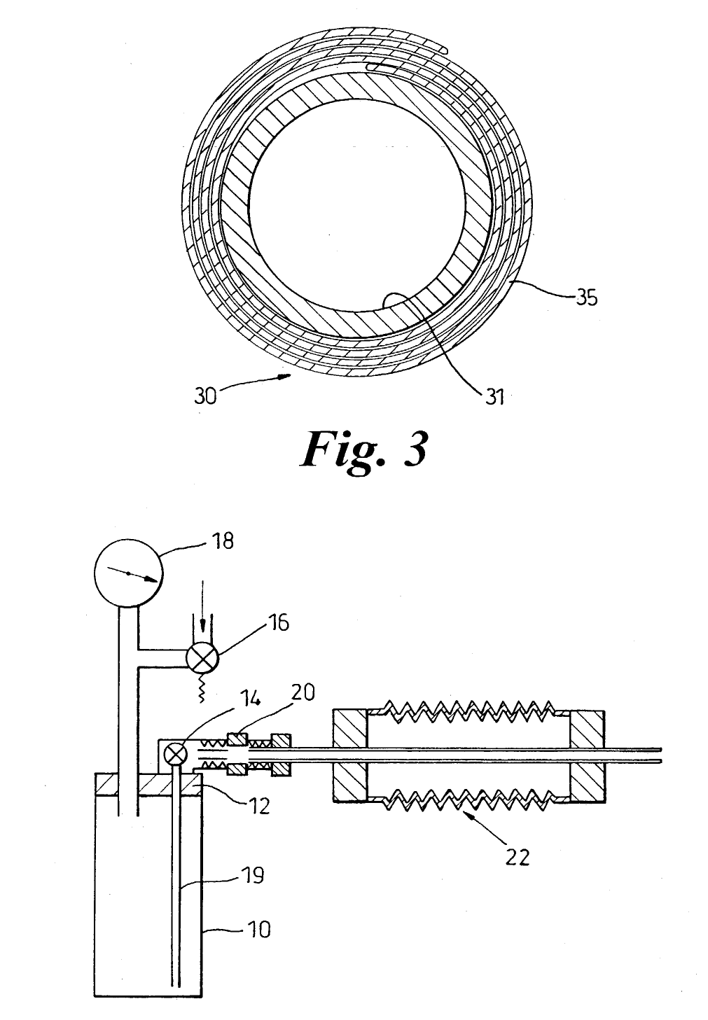

FIG. 3 illustrates the cross-section of the tubular article 30 depicted in FIG. 2 after the tubular article is removed from the mandrel. Optionally, film 35 may be circumferentially wrapped atop of a base tube 31.

When producing a multi-layered article, such as a tube as in FIGS. 2 and 3, the multi-layered film assembly is heated at sufficient temperature and a long enough time to ensure bonding of the layers. Insufficient heating may result in a tube prone to delamination. The number of film layers may be varied in order to optimize tube strength, tube LNLP, tube wall thickness, and tube flexibility. The diameter of the mandrel may be varied to produce a tube of a desired inner diameter.

Although the embodiments of FIGS. 2 and 3 are in the form of tubes, it will be readily apparent to those of skill in the art that articles in accordance with embodiments of the present invention may take a variety of tubular forms, such as having circular, oblong, rectangular, or other regular or irregular cross-sections. Other forms may include membranes, pouches, bags, or other containers, or transfer devices.

FIG. 4 illustrates a test apparatus for the controlled delivery of cryogenic liquid from Dewar flask 10 through one embodiment of a transfer tube 22 of the present invention. The transfer tube 22 is secured to the Dewar flask 10 via compression fitting 20. Cryogenic liquid is introduced into the Dewar 10 and the lid 12 is secured. The pressure at the top of the enclosed flask is monitored by pressure transducer or gauge 18. The pressure is regulated by a regulator 16. Once outlet valve 14 is opened, the fluid passes through the dip tube 19 that extends from near bottom of the flask through the valve 14 and through the transfer tube 22.

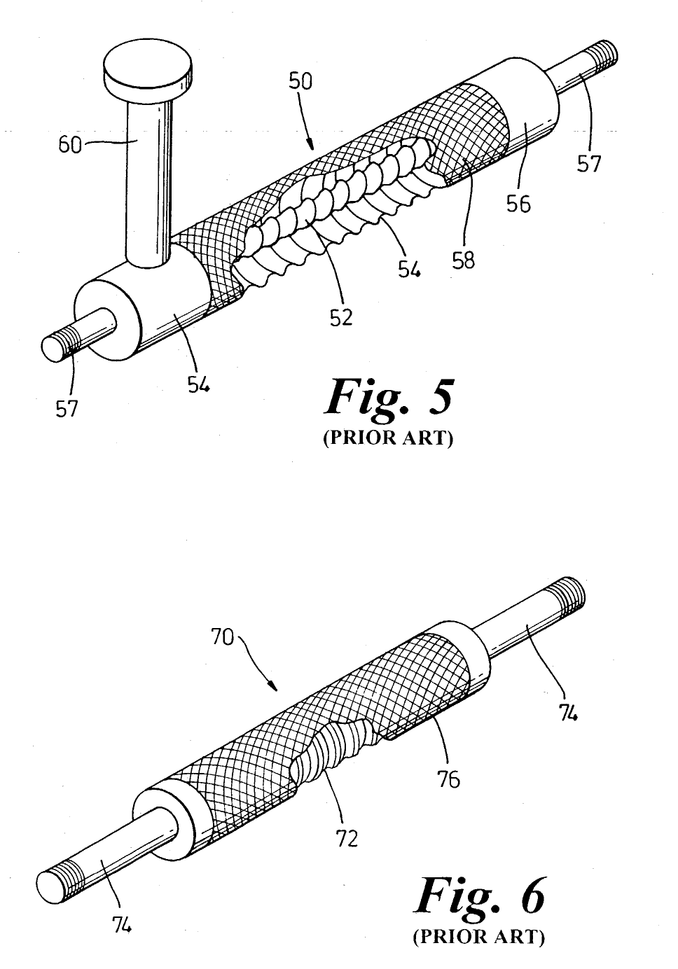

Prior art transfer tubes are illustrated in FIGS. 5 and 6. Referring to FIG. 5, a protective stainless steel braid 58 comprises the exterior surface of the vacuum-insulated flexible transfer tube 50. The transfer tube consists of a coaxial construction of two corrugated or convoluted stainless steel tubes 52 and 54. The coaxial space is sealed on both ends with welded fittings 56 and 57. A vacuum port 60 is also provided.

A non-insulated flexible transfer tube 70 is depicted in FIG. 6. A protective stainless steel braid 76 comprises the outer surface of the transfer tube. The transfer tube consists of a single corrugated or convoluted stainless steel tube 72. Welded fittings 74 are provided for connecting the transfer tube for use.

The following tests are employed to characterize the tubes of the present invention:

Bubble Point and Thickness Testing for Films

Bubble point of films is measured according to the procedures of ASTM F31 6-86. The film is wetted with isopropanol (IPA).

Film thickness is measured with a snap gauge (such as Model 2804-10 Snap Gauge available from Mitutoyo, Japan).

Gurley Air Permeability Testing for the Film

The resistance of samples to airflow is measured by a Gurley densometer, such as that manufactured by W. & L. E. Gurley & Sons, in accordance with conventional measurement procedures, such as those described in ASTM Test Method D726-58. The results are reported in terms of Gurley Number, or Gurley-Seconds, which is the time in seconds for 100 cubic centimeters of air to pass through 1 square inch of a test sample at a pressure drop of 4.88 inches of water.

Isopropanol Bubble Point, Gurley Air Permeability and Tube Dimension Measurement Testing for the Tubes

The tubes are mounted to barbed luer fittings and secured with clamps and tested intact.

The isopropanol (IPA) bubble points (IBP) are tested by first soaking the tubing fixtures in IPA for approximately six hours under vacuum, then removing the tubing from the IPA and connecting the tubing to an air pressure source and re-immersing the tube in IPA in a transparent container. Air pressure is then manually increased at a slow rate until the first steady stream of bubbles is detected. The corresponding pressure is recorded as the IBP.

The air permeability measurement is determined using a Gurley Densometer (such as a Model 4110 densometer from W. & L. E. Gurley, Troy, N.Y.) fitted with an adapter plate that allows the testing of a length of tubing. The average internal surface area is calculated from the measurements utilising a Ram Optical Instrument (such as a Model OMIS II 6×12 from Ram Optical Instrumentation Inc., 15192 Triton Lane, Huntington Beach, Calif.). The Gurley Densometer measures the time it takes for 100 cc of air to pass through the wall of the tube under 4.88 inches (12.40 cm) of water head of pressure. The air permeability value is calculated as the inverse of the product of the Gurley number and the internal surface area of the tube expressed in units of cc/min cm².

The wall thickness and outer diameter of the tube are measured using the same OMIS II optical system.

### Cryogenic Liquid Delivery Test

A cryogenic liquid delivery test was developed to characterise the effectiveness of transfer tubes to deliver cryogenic fluids.

A schematic representation of the test apparatus appears in FIG. 4. A 1.8 litre Dewar flask 10 (such as a Cryogun Dewar flask from Brymill Cryogenic Systems, Ellington, Conn.) is obtained (a larger flask may be used if desired). The Dewar flask lid 12 is dried to avoid the outlet valve 14 becoming blocked due to moisture ingress leading to accumulation of ice particles. The Dewar flask 10 is filled with liquid nitrogen and the lid 12 slowly screwed onto the canister, allowing excess liquid nitrogen to boil off.

Air pressure is applied to the top of the liquid nitrogen reservoir. The pressure is regulated via a precision regulator 16 (such as a Moore Model 41-100). A pressure monitoring tap is included in the line entering the flask for safety reasons. The Dewar flask 10 inlet pressure is measured with a multi-port pressure transducer (such as a Heise, Model PM, Newtown, Conn.) or gauge 18. Liquid nitrogen is forced out of the flask through a 0.100 inch (2.54 mm) inner diameter stainless steel dip tube 19 that extends from near the bottom of the flask to outlet valve 14. A lever outlet valve 14 at the head controls the exit flow. A threaded tube compression fitting 20 with a 0.125 inch (3.18 mm) inner diameter is attached to outlet valve 14.

One end of the transfer tube 22 is attached to the tube compression fitting 20. The other end of the tube is attached to a sintered bronze pneumatic muffler (such as a Part #4450K1 from McMaster-Carr, Los Angeles, Calif.) (not shown). The muffler directs the liquid nitrogen flow in a controlled stream for accurate collection.

The transfer tube 22 is positioned horizontally. The test is performed at ambient conditions.

The transfer tube 22 is tested in the following manner. The Dewar flask outlet valve 14 is opened. The pressure regulator 16 is adjusted to 1 psi (0.007 MPa). All fittings and connections are examined to ensure that no leaks are present. The discharge of liquid nitrogen out of the bronze muffler is readily confirmed by placing an expanded PTFE membrane in the path of the exiting nitrogen and noting wetting of the membrane. The time to deliver the liquid is measured from the time of opening the Dewar valve until the first drop wets the membrane. The time from opening the valve to deliver a quantity of liquid nitrogen in 10 gram increments is also measured. The liquid is captured in a glass-stainless steel open vacuum Dewar (such as a Dilvac®, Part #SS111 from Day-Impex Ltd., Earls Colne, UK) (not shown) which rests atop a scale (such as a Sauter RL4, model RL4-02 from August Sauter GmbH, Albstadt-Ebingen, Switzerland) (not shown).

Bending Diameter Test

Five minutes after the opening of the Dewar valve, which initiates the cryogenic delivery test, the transfer tube is wrapped around the outside of a series of successively smaller hollow cylinders to determine the bending diameter. Liquid nitrogen continues to flow through the tubes during the test. The tube is examined for evidence of kinking. The outer diameter of the smallest cylinder around which the transfer tube can be wrapped with at least one full wrap without kinking or fracturing is recorded as the bending diameter. “Kinking” is defined as a crease in one or more of the tubular components. Smaller values for bending diameter indicate greater tube flexibility.

The tube is also visually examined for evidence of fracture, to determine if the wrapping had compromised the ability of the tube to hold liquid.

Liquid Nitrogen Leak Pressure Test

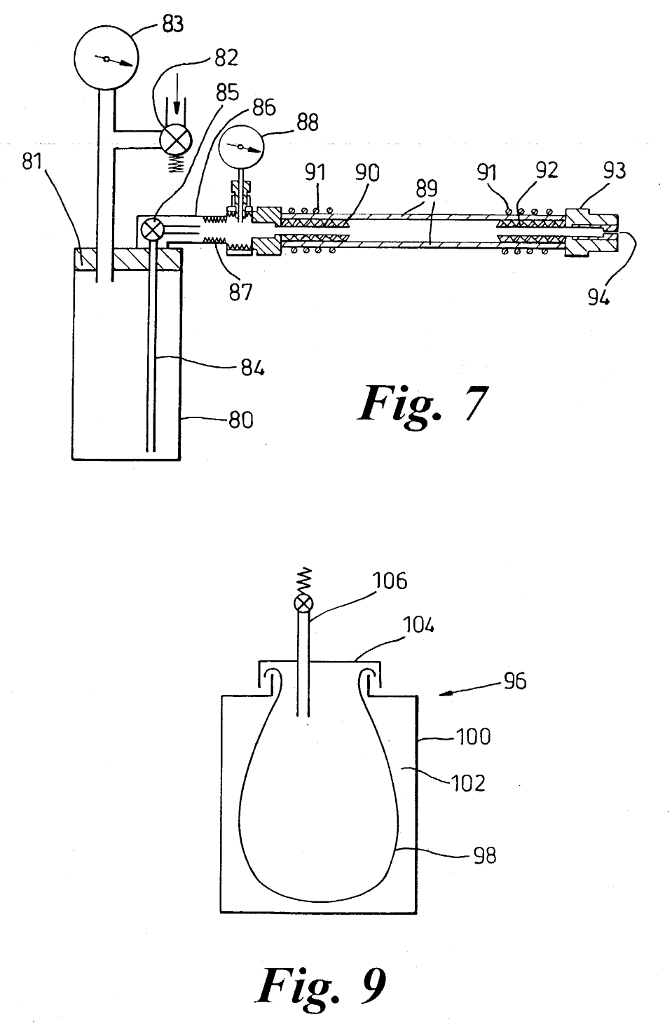

A liquid nitrogen leak pressure test was developed to measure the pressure at which liquid nitrogen permeates through a cryogen tube wall. Liquid nitrogen is added to the lumen of tested tubes and pressurised. The tube is examined to ensure the permeation of gaseous nitrogen through the tube wall. The pressure at which liquid nitrogen leaks through the walls of the tube is noted and recorded. This pressure corresponds to the pressure at which the mass flow rate of liquid nitrogen flowing through the wall in the radial direction exceeds the mass evaporation rate of the liquid at the outer wall surface. A schematic representation of the test apparatus appears in FIG. 7. A 0.5 Litre Dewar flask 80 (such as a CRYO JEM from Cryomedical Instruments Ltd., Nottinghamshire, UK) is obtained (a larger flask may be used if desired.) The Dewar flask lid 81 is dried to avoid the outlet valve 85 becoming blocked due to moisture ingress leading to accumulation of ice particles. The Dewar flask 80 is filled with liquid nitrogen and the lid 81 slowly screwed onto the canister allowing excess liquid nitrogen to boil off.

Air pressure is applied to the top of the liquid nitrogen reservoir. The pressure is regulated via a precision regulator 82 (such as a Moore Model 41-100). A pressure monitoring tap is included in the line entering the flask for safety reasons. The Dewar flask 80 inlet pressure is measured with a multi-port pressure transducer (such as a Heise, model PM. Newtown, Conn.) or gauge 83. Liquid nitrogen is forced out of the flask through a 0.062 inch (1.58 mm) inner diameter stainless steel dip tube 84 that extends from near the bottom of the flask to an opening in the flask lid 81. A lever valve 85 at the head controls the exit flow. The dip tube 84 extends beyond this valve 85, enclosed in a larger plastic conduit 86. Threaded fittings 87 are attached to the larger conduit 86. Another pressure monitoring tap is included in the line in order to measure the inlet pressure to the tested tube (using the same pressure monitor as described above or gauge 88). A standard barb fitting 90 is screwed into the fitting 87.

The tube 89 to be tested is cut to a length of 180 mm. The test length is about 135 mm since portions of the ends are attached over fittings 90, 92. One end of the tube 89 is attached over the barb fitting 90 and secured by wrapping silver plated copper wire 91 tightly around the outside of the tube 89. The other end of the tube 89 is fitted with a barb fitting 92 and secured in the same manner. The outlet of this barb 92 fitting is fitted with a 0.50 inch (12.7 mm) long PTFE cylindrical plug 93. The plug 93 has a 0.062 inch (1.58 mm) diameter, 0.075 inch (1.90 mm) long hole 94 drilled through its centre, which is counter-bored to 0.125 inch (3.18 mm) diameter for a length of 0.425 inch (10.8 mm). The outlet orifice diameter and dip tube inside diameter are specified to match. These are the smallest flow restrictions in the line exiting the flask. This choice of outlet orifice 94 and dip tube inside diameter enables a sufficient test duration before exhausting the liquid nitrogen from the flask. Venting the outlet to atmosphere enhances the flow of liquid nitrogen into the tube to be tested.

The tube 89 is positioned horizontally. The test is performed under a hood at ambient conditions: room temperature is 19.6° C., relative humidity is about 46% and in essentially still air. The nitrogen exiting the end of the tube is directed outside of the hood in order not to disturb the air flow under the hood.

The tube 89 is tested in the following manner. The Dewar flask lever valve 85 is opened. The pressure regulator 82 is adjusted until liquid nitrogen exits the orifice 94 at the end of the test sample tube. The discharge of liquid nitrogen is readily confirmed by placing an expanded PTFE membrane in the path of the exiting nitrogen and noting wetting of the membrane. All fittings and connection are examined to ensure that no leaks are present. The tube 89 is then examined for gaseous permeation of nitrogen through its wall, along the length of the tube as evidenced by a plume of condensed water vapour in the vicinity of the tube. The applied pressure is adjusted until such a steady plume is observed. A steady plume indicates both gas permeation and that the air is still in the test environment. The plume as described demonstrates that gaseous nitrogen is exiting along the length of the tube 89, which is indicative of distributed evaporative cooling. Note that the pressure increase in the Dewar flask 80 resulting from the evaporation of the nitrogen alone may be sufficient to pressurise the tube 89.

The tube under test is allowed to chill for a period of 30 seconds prior to further pressure adjustment. The pressure is increased until the first droplet of liquid nitrogen appears on the outer surface of the tested tube 89. The pressure regulator 82 is slowly and slightly opened and closed to ensure that this is the pressure corresponding to the formation of the first stable droplet. A stable droplet is one that under constant pressure, remains about the same size during testing for at least 5 seconds, without dripping. By decreasing the pressure the droplet will evaporate. With increasing pressure, the droplet size increases past stability until liquid is first dripping rapidly and then running out of the tube wall. The pressure measured at the entrance to the tested tube 89 is recorded. This average of three pressure readings, taken at intervals of at least 20 seconds as measured with the pressure gauge 88 is recorded as the liquid nitrogen leak pressure. Venting the tube 89 to atmosphere via the use of the plug 93 with the 0.062 inch (1.58 mm) orifice 94 is important to achieve the distribution of liquid nitrogen across the length of the tube 89. Tubes in accordance with the preferred embodiments of the present invention permeate the most gas when liquid cryogen is present on the interior surface.

Whereas this test was developed specifically for testing tubes, the same principles may be applied to create a test for the examination of the properties of other shapes of materials. The important elements of the test include: controlled application of pressure and ability to measure the pressure required to force a mass of liquid nitrogen sufficient to form a stable drop of liquid on the outside wall of the test article, through the thickness of the article while the internal surface of the article is in contact with liquid.

Without intending to limit the scope of the present invention, the following example is illustrative of how one embodiment of the present invention may be made and used.

### EXAMPLE

A thin longitudinally expanded PTFE base tube possessing a wall thickness of 0.131 mm, an inner diameter of 4.0 mm, Gurley number of 0.9 sec, and an IBP of 0.79 psi (0.0055 MPa) is obtained. Referring to FIG. 2, this tube 31 is snugly slipped over 0.180 inch (4.6 mm) diameter mandrel 33.

Expanded PTFE film 35 is obtained possessing a thickness of 0.0034 inch (0.086 mm), a Gurley number of 37.1 seconds, and an isopropanol bubble point of 50.3 psi (0.342 MPa). All measurements are made in accordance with the procedures previously described, unless otherwise indicated. This ePTFE film is then circumferentially wrapped over the thin ePTFE base tube such that the width of the film becomes the length of the resultant tube as depicted in FIG. 2. Twenty layers of film are wrapped around the base tube. The cross-sectional geometry of the layered tube construction 30 is spiral-shaped as indicated in FIG. 3.

The ends of the layered film and base tube construction are restrained by suitable clamping means to prevent shrinkage in the longitudinal direction of the construction (the longitudinal axis of the mandrel) during subsequent heat treatment.

The restrained tube construction is submerged in a 365° C. molten salt bath oven for 2.0 minutes in order to bond the ePTFE layers and impart dimensional stability to the tube. The tube is allowed to cool then washed in ambient temperature water to remove residual salt. The clamps are removed and the tube is removed over the end of the mandrel.

The tube length is about 45 inch (1.14 m). A portion of the tube, a 0.75 inch (19.0 mm) sample length, is used for the measurement of outer diameter, wall thickness, Gurley number, air permeability, and IBP in accordance with the techniques previously described. The values of three samples per tube are obtained and averaged for the outer diameter and the thickness measurements. One Gurley air permeability and one isopropanol (IPA) bubble point measurement are made per tube. The outer diameter is 6.13 mm and the wall thickness is 0.828 mm. The Gurley number is >58800, expressed in units of seconds per 100 cc of air at 4.88 inches (12.4 cm) of water. The air permeability is <0.056 cc/min cm². The IBP is >85.0 psi (>0.586 MPa).

The entire coaxial tube assembly (i.e., the transfer tube 22) is depicted in FIG. 4. Three round DELRIN® spacers 42 are then placed over the tube 30 along its length to support the tube when it is coaxially placed inside a larger tube 44. The use of more spacers per unit length results in a more uniform coaxial geometry with increased bending of the transfer tube. Spacers placed about every 3 inch (76.2 mm) optimise the bending diameter characteristics of this tube of this example.

The spacers 42 contain a 0.238 inch (6.0 mm) central bore. Each spacers is 1.2 inch (30.5 mm) in diameter with eight 3/16 inch (4.8 mm) holes 49 drilled around its perimeter. These holes permit the passage of gas through the spacers.

The outer tube 44 is a convoluted TEFLON® PTFE tubing (such as a Part number 51155K8 from McMaster-Carr, Los Angeles, Calif.) possessing a nominal inner diameter of 1.25 inch (31.7 mm). Hollow end caps 46 are positioned inside the outer tube and over the ePTFE inner tube 30. The length and mass of the transfer tube 22 are 39.25 inch (1.00 m) and 465.5 g, respectively. Fittings, which include a brass muffler, used for testing (not shown) are not included in the length and weight measurements. An optional protective covering, such as a stainless steel braid or braid constructed from another material, may be added to the exterior surface of the present transfer tube. The preferred protective covering of the present invention is non-metallic, so as to contribute minimal weight, minimal density, and minimal reduced flexibility. Suitable non-metallic braids include ePTFE fibers, PFTE fibers, aramide fibers (such as KEVLAR® fiber), polyamide fibers, polyethylene fibers, etc.

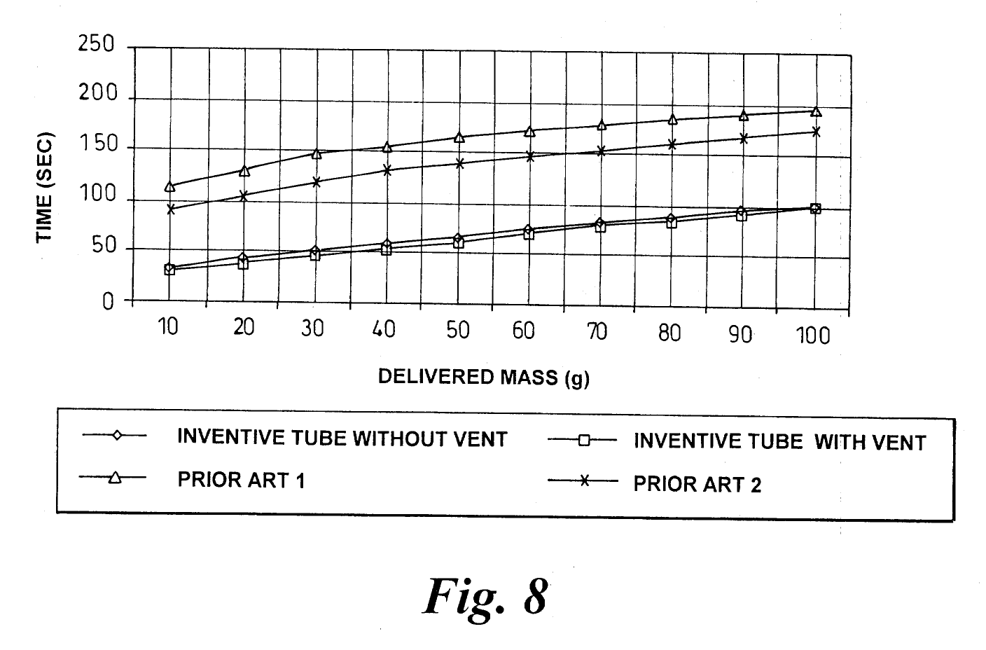

A vacuum-insulated flexible transfer tube 50 of the prior art, as shown in FIG. 5, is obtained from A. S. Scientific, Ltd. (Abington, Oxford, U.K.). The transfer tube consists of two coaxial stainless steel corrugated tubes 52 and 54 with welded fittings 56 and 57 on the ends, and a protective stainless steel wire braid 58 over the exterior. A vacuum port 60 is provided on one end to draw and retain a vacuum in the coaxial space. The inner diameter of the inner tube 52 is approximately 0.18 inch (4.57 mm) as measured at the smaller fitting 57. The inner diameter of the outer tube 54 is approximately 1.24 inch (31.50 mm) as measured on the outside of the larger welded fitting 56. The outer diameter of the braided section 58 is 1.47 inch (37.33 mm). The length and mass of the transfer tube as depicted in FIG. 5 are 35.5 inch (0.90 m) and 1738 g, respectively. Fittings used for testing (not shown) are not included in the length and weight measurements. This tube is referred to as Prior Art 1 in Table 1 and FIG. 8.

A commercially available stainless steel cryogenic liquid transfer tube is obtained (part number: 3701004, Statebourne Cryogenic, Ltd., Washington, Tyne and Wear, U.K.). Referring to FIG. 6, the transfer tube 70 comprises a single stainless steel corrugated tube 72 with welded fittings on the ends 74 and a protective stainless steel wire braid 76 over the exterior. The inner diameter of the tube 72 is approximately 0.50 inch (12.7 mm) as measured at the fittings 74. The outer diameter is 0.815 inch (20.7 mm). The length and mass of the transfer tube as depicted in FIG. 6 are 37.5 inch (0.953 m) and 489.2 g, respectively. Fittings used for testing (not shown) are not included in the length and weight measurements. This tube is referred to as Prior Art 2 in Table 1 and FIG. 8.

The inventive coaxial transfer tube and the prior art transfer tubes are attached to the liquid nitrogen supply and tested in accordance with the cryogenic liquid delivery test as described above. Referencing FIG. 1, a 0.159 inch (4.04 mm) hole 48 is then drilled through the downstream end cap 46 of the inventive transfer tube 22 in order to vent the coaxial chamber. The cryogenic liquid delivery test is also performed on this sample. The tests are performed at ambient temperature. The results for all four tests follow:

TABLE 1

| | Time (sec) | | | |
|---|---|---|---|---|
| | Inventive Tube | Inventive Tube | Prior | Prior |
| Delivered Mass (g) | without Vent | with Vent | Art 1 | Art 2 |
| first drop | 19 | 21 | 27 | 71 |
| 10 | 33 | 31 | 114 | 91 |
| 20 | 43 | 39 | 129 | 103 |
| 30 | 52 | 47 | 146 | 119 |
| 40 | 59 | 54 | 154 | 131 |
| 50 | 66 | 62 | 164 | 138 |
| 60 | 76 | 72 | 171 | 146 |
| 70 | 83 | 80 | 179 | 152 |
| 90 | 90 | 86 | 185 | 160 |
| 90 | 96 | 93 | 191 | 167 |
| 100 | 102 | 99 | 196 | 174 |

The inventive transfer tube delivers the first drop of liquid nitrogen in significantly less time than either of the prior art transfer tubes. The inventive transfer tube performs essentially the same with or without a vent hole with regard to delivery of liquid nitrogen as a function of time. The inner tube of the present invention does not leak liquid nitrogen during the test. These four sets of data are graphically represented in FIG. 8.

The bending diameter is also measured per the technique described above 5 minutes after opening of the Dewar valve. The bending diameter for the inventive tube, prior art tube 1 and prior art tube 2 are 1.5 inch (38.1 mm), 5 inch (127 mm) and 3 inch (76.2 mm), respectively. The presence or absence of the vent in the inventive article does not affect the bending diameter.

It has also been noted that that particular embodiments of the transfer tube of the present invention are significantly lighter than current commercially available cryogenic fluid transfer tubes. As noted above, current tubes typically are constructed from numerous metal components that are dense, heavy, and unwieldy. By contrast, the use of plastic component parts in embodiments of the present invention, and preferably a tube constructed entirely from non-metal components, has dramatically less weight per unit length than presently available cryogenic fluid transfer tubes. Since tubes vary in weight per unit length by their cross-sectional dimensions, it is difficult to estimate just how dramatic the improvement in weight is by employing the present invention, but it is believed that weight can be readily decreased by 50% or more by constructing a tube as described herein instead of using conventional metal components of similar dimensions.

Another measure of the significant weight advantage of particular embodiments of the tube of the present invention is that the tube has dramatically less density than currently available cryogenic fluid transfer tubes. By way of example, the relative densities of two tubes are tested. The first tube is a commercially available cryogenic transfer tube comprising an impermeable metal inner tube, a corrugated metal outer tube, a metal protective braid, measuring about 90 cm in length and about 37 mm in diameter and a mass of about 1.7 kg. The second tube is a tube of the present invention comprising a porous inner tube of ePTFE and a corrugated outer tube of PTFE measuring about 100 cm in length and about 32 mm in inner diameter and a mass of about 0.5 kg. Both tubes are capped at their ends so that liquid does not enter the inner tubes. The tubes are then placed in a large vat of water and their relative buoyancy is observed. It is determined that the conventional metal tube has a density much greater than water and the tube immediately sinks to the bottom of the vat. By comparison, the inventive tube has a density less than that of water and the inventive tube readily floats in the vat. Thus, it can be concluded that the density of the tube of the present invention is less than about 1 g/cc.

A further embodiment of the present invention is illustrated in FIG. 9. As has been noted, embodiments of the present invention may be employed in a variety of applications for the containment and/or transfer of cryogenic liquids and the like, such as a membrane, pouch, or container. FIG. 9 illustrates a transfer container 96 of the present invention comprising a permeable membrane 98 formed into an inner container, such as a porous ePTFE membrane as previously described, that is used to line an impermeable outer shell 100, as a flask constructed from rigid polymer, stainless steel, or the like. The outer shell 100 may alternatively be constructed from a flexible impermeable materials, such as an impermeable flexible plastic, forming a bag-in-a-bag construct. A gap 102 is provided between the membrane 98 and the shell 100 that may fill with gaseous fluid, as in the manner previously described. The container includes a cap 104 to seal the fluid within the container. One or more transfer tubes (not shown) may be included through the cap 104 to assist in moving fluid into or out of the container such as with a Dewar flask as previously described. One or more pressure relief valves 106 are provided to release excess pressure from either the interior of the inner container and/or from the gap 102. It should be evident from this embodiment of the present invention that the present invention may be incorporated into a wide variety of shapes and sizes to assist in the storage and transfer of cold fluids. As such, the terms “tube”, “wall” and “container” should be broadly read to include any structure than can be used to contain fluid within the context of the present invention.

While particular embodiments of the present invention have been illustrated and described herein, the present invention should not be limited to such illustrations and descriptions. It should be apparent that changes and modifications may be incorporated and embodied as part of the present invention within the scope of the following claims.

The invention claimed is:

1. A cryogenic fluid transfer conduit system comprising:
a permeable inner tube adapted to contain a liquid cryogenic fluid therein and having a tube wall which allows passage of a gaseous phase of the cryogenic fluid therethrough, while inhibiting the passage of a liquid phase of the cryogenic fluid;
an outer tube, the outer tube being mounted around the inner tube; and
a gap between the inner tube and the outer tube, wherein in use the gap contains the gaseous phase of the cryogenic fluid to assist in insulating the inner tube.

2. The fluid transfer conduit system of claim 1 wherein the inner tube is mounted coaxially within the outer tube.

3. The fluid transfer conduit system of claim 1 wherein the cryogenic fluid comprises liquid nitrogen.

4. The fluid transfer conduit system of claim 1 wherein the system includes a vent to release gaseous cryogenic fluid to atmosphere.

5. The fluid transfer conduit system of claim 1 wherein the system includes a vent to release gaseous cryogenic fluid to a containment chamber.

6. The fluid transfer conduit system of claim 1 wherein a gaseous phase of the cryogenic fluid supply is included to feed the gaseous phase of the cryogenic fluid into the gap.

7. The fluid transfer conduit system of claim 1 wherein the outer tube is impermeable.

8. The fluid transfer conduit system of claim 1 wherein the outer tube is corrugated.

9. The fluid transfer conduit system of claim 1 wherein the inner tube is corrugated.

10. The fluid transfer conduit system of claim 1 wherein the gap is devoid of spacer material.

11. The fluid transfer conduit system of claim 1 wherein the inner tube is a porous polymer.

12. The fluid transfer conduit system of claim 1 wherein the inner tube is a porous fluoropolymer.

13. The fluid transfer conduit system of claim 1 wherein the inner tube is porous ePTFE.

14. The fluid transfer conduit system of claim 1 wherein the inner tube is porous PTFE.

15. The fluid transfer conduit system of claim 1 wherein the inner tube is a porous ceramic.

16. The fluid transfer conduit system of claim 1 wherein the inner tube is a porous sintered metal.

17. The fluid transfer conduit system of claim 1 wherein the inner tube incorporates a reinforcing member.

18. The fluid transfer conduit of claim 17 wherein the reinforcing member is in the form of a braid.

19. The fluid transfer conduit system of claim 1 wherein the outer tube incorporates a reinforcing member.

20. The fluid transfer conduit system of claim 19 wherein the reinforcing member is in the form of a braid.

21. The fluid transfer conduit system of claim 1 wherein the outer tube is permeable.

22. The fluid transfer conduit system of claim 1 wherein the outer tube is a fluoropolymer.

23. The fluid transfer conduit system of claim 1 wherein the outer tube is a metal.

24. A process for the transfer of cryogenic fluids that employs the fluid transfer conduit system of claim 1.

25. The fluid transfer conduit system of claim 1 wherein the outer tube includes openings therein to allow for controlled venting.

26. The fluid transfer conduit system of claim 1 that further includes at least one spacer dividing the gap into multiple sections.

27. The fluid transfer conduit system of claim 26 wherein the spacer includes openings therein to provide gaseous communication between tube sections.

28. The fluid transfer conduit system of claim 1 wherein the conduit has a density less than distilled water.

29. The fluid transfer conduit system of claim 1 wherein spacers are provided at intervals along the length of the conduit.

30. The fluid transfer conduit system of claim 1 wherein the inner tube comprises a layered construction.

31. The fluid transfer conduit system of claim 1 wherein the conduit system has density of less than 1 g/cc.

32. The fluid transfer conduit system of claim 1 wherein the gap is adapted to contain the gaseous phase of the cryogenic fluid at or above ambient pressure.

33. A cryogenic fluid storage container comprising:
a permeable membrane forming an inner container to contain the cryogenic fluid in a liquid form;
an impermeable shell surrounding the membrane; and
an enclosed gap between the inner container and the shell, wherein in use the gap receives gaseous cryogenic fluid that exits the inner container through the permeable membrane.

34. A method of transferring a liquid cryogenic fluid between two spaced locations, the method comprising the steps of:
providing a cryogenic fluid transfer conduit comprising a permeable inner tube, an outer tube mounted around the inner tube, and a gap between the inner tube and the outer tube;
passing the liquid cryogenic fluid through the permeable inner tube; and
retaining the liquid phase of the fluid within the inner tube while allowing a gaseous phase of the fluid to pass from the inner tube into the gap such that the gaseous phase of the cryogenic fluid is contained in the gap to assist in insulating the inner tube.

35. A fluid transfer system comprising:
a permeable inner tube adapted to contain a liquid cryogenic fluid;
an outer tube, the outer tube being mounted around the inner tube; and
a gap between the inner tube and the outer tube, the gap adapted to contain a gaseous phase of the cryogenic fluid to assist in insulating the inner tube.
